(19) United States
(12) Patent Application Publication
(10) Pub. No.: US 2024/0149343 A1
(43) Pub. Date: May 9, 2024

(54) SILVER POWDER AND METHOD OF PRODUCING SAME

(71) Applicant: DOWA Electronics Materials Co., Ltd., Chiyoda-ku, Tokyo (JP)

(72) Inventors: Yuma HIGASHI, Okayama-shi, Okayama (JP); Shingo TERAGAWA, Honjo-shi, Saitama (JP)

(73) Assignee: DOWA Electronics Materials Co., Ltd., Chiyoda-ku, Tokyo (JP)

(21) Appl. No.: 18/549,587

(22) PCT Filed: Mar. 16, 2022
(86) PCT No.: PCT/JP2022/012095

§ 371 Date: Sep. 8, 2023

(30) Foreign Application Priority Data
Mar. 26, 2021 (JP) 2021-054209
Mar. 8, 2022 (JP) 2022-035699

(51) Int. Cl. B22F 9/04; B22F 1/05; B22F 1/145; H01B 1/20

(52) U.S. Cl. CPC B22F 9/04; B22F 1/05; B22F 1/147; B22F 2301/255; B22F 2304/10; B22F 2998/10; H01B 1/20

(57) ABSTRACT

Provided are a silver powder and a method of producing the same. The method of producing the silver powder includes a first surface smoothing step of causing fine silver particles having internal voids to mechanically collide with one another; a fine powder removal step of dispersing fine silver particles present after the first surface smoothing step using high-pressure airflow while removing fine powder; and a second surface smoothing step of causing fine silver particles present after the fine powder removal step to mechanically collide with one another.

### TECHNICAL FIELD

The present disclosure relates to a silver powder and a method of producing the same.

### BACKGROUND

Silver powders are used as materials (fillers) in conductive pastes that are used for wiring, electrical contacts such as electrodes, and so forth in various electronic components such as solar cells, semiconductors, and capacitors, for example. Patent Literature (PTL) 1 describes a silver powder and a method of producing this silver powder. The silver powder described in PTL 1 is produced by subjecting a silver powder produced by a wet reduction method to a surface smoothing process in which particles are caused to mechanically collide with one another and by subsequently removing agglomerates by classification.

### CITATION LIST

### Patent Literature

PTL 1: JP2005-240092A

### SUMMARY

### Technical Problem

A wire or contact of an electronic component that is produced through application of a conductive paste (hereinafter, also referred to simply as a paste) is obtained by applying the paste through printing or the like and then subsequently heating (typically firing) the applied paste. One preferable characteristic for a conductive paste is that it is easy to apply or print as in a desired pattern. Another preferable characteristic of a conductive paste is that it has good electrical conductivity, does not suffer disconnection, and is not easily peeled off after heating.

In recent years, the ability to perform low-temperature firing when obtaining an electrode has also been demanded as a characteristic of conductive pastes. In other words, there is demand for a conductive paste having characteristics of good electrical conductivity, lack of disconnection, and resistance to peeling even when firing thereof is performed at a low temperature. The formation of thinner wires in recent years has made it desirable that, in particular, a conductive paste enables thinner wire formation (has high printability) and has low susceptibility to disconnection.

Note that when fine silver particles that are used in a conductive paste contain voids, the contraction onset temperature is reached earlier during heating (during firing) as compared to a case in which the fine silver particles have a substantially solid structure (i.e., the inside of the fine silver particles is filled in). This behavior in response to heat that is displayed by fine silver particles having internal voids is advantageous in terms of enabling low-temperature firing.

The present disclosure is made in light of the circumstances set forth above, and an object thereof is to provide a method of producing a silver powder that contains fine silver particles having internal voids and that is capable of providing a conductive paste that is advantageous in low-temperature firing and that has low susceptibility to wire disconnection even upon wire thinning, and also to provide this silver powder.

### Solution to Problem

A method of producing a silver powder according to the present disclosure for achieving the object set forth above comprises:
a first surface smoothing step of causing fine silver particles having internal voids to mechanically collide with one another;
a fine powder removal step of dispersing fine silver particles present after the first surface smoothing step using high-pressure airflow while removing fine powder; and
a second surface smoothing step of causing fine silver particles present after the fine powder removal step to mechanically collide with one another.

A silver powder according to the present disclosure for achieving the object set forth above comprises fine silver particles having internal voids and having surfaces with an arithmetic average roughness of 3 nm or less in profile roughness measurement.

Moreover, in a case in which the measurement method of the surface state is changed to surface roughness measurement using a scanning probe microscope instead of profile roughness measurement, the silver powder comprises fine silver particles having internal voids and having surfaces with an arithmetic average roughness of 4.9 nm or less in surface roughness measurement of a 500 nm×500 nm area.

As a result of diligent and extensive research, the inventors found that in order to achieve high printability and low susceptibility to disconnection even upon wire thinning (i.e., in order to enable wire thinning), it is preferable for fine silver particles serving as a filler to have even smoother surfaces. However, the inventors also found that in the case of fine silver particles having internal voids that enable low-temperature firing, irregularities readily form at the surfaces of these fine silver particles in the production process thereof (for example, a wet reduction method).

Moreover, it was found that with the conventional technique described in PTL 1, when a silver powder including fine silver particles that have internal voids and surface irregularities is subjected to a surface smoothing processing method of causing the particles to mechanically collide with one another using a stirrer (mixer, mill, etc.), it is difficult to obtain particle surfaces that are smoother than a certain level even by making various alterations to the processing conditions.

Besides a surface smoothing processing method in which particles are caused to mechanically collide with one another such as described above, examples of other methods that are envisaged include a method of performing heat treatment of fine silver particles to obtain fine silver particles having smooth surfaces and a method of obtaining fine silver particles having smooth surfaces in a state in which the fine silver particles are produced by a wet reduction method. However, these methods produce fine silver particles that are substantially solid.

In response to the above, the inventors conceived of the present disclosure, which encompasses a concept of splitting up and performing a mechanical smoothing process a plurality of times and of dispersing fine silver particles using high-pressure airflow while removing fine powder in an interval in this smoothing process. According to the present disclosure, it is possible to sufficiently improve smoothness of fine silver particles even in the case of a silver powder having internal voids. This makes it possible to provide a silver powder capable of providing a conductive paste that is advantageous in low-temperature firing and that has low susceptibility to wire disconnection even upon wire thinning.

The smoothness improvement described above may arise for the following reason, for example. In a situation in which scraps (fine powder) produced through collisions between fine silver particles remain in a processing space in which particles are caused to mechanically collide with one another, these scraps may become reattached to the surfaces of fine silver particles, thereby forming surface irregularities, or may function like a glue that links or bridges between fine silver particles and thereby promotes formation of agglomerates of fine silver particles. Therefore, in a state in which scraps produced through collisions remain inside the processing space, it is difficult to obtain particle surfaces that are smoother than a certain level even by altering conditions, such as by extending the processing time.

For this reason, the fine powder removal step is performed to remove fine powder from the silver powder after the first surface smoothing step has been performed, and then the second surface smoothing step is further performed. Consequently, formation of irregularities and production of agglomerates through ultrafine powder can be inhibited while the second surface smoothing step is being performed, and an effect of promoting reduction of surface roughness of the fine silver particles can be achieved in the smoothing process. As a result, the method of producing fine silver particles according to the present disclosure makes it possible to achieve the provision of a silver powder that contains fine silver particles having internal voids and that is capable of providing a conductive paste that is advantageous in low-temperature firing and has low susceptibility to wire disconnection even upon wire thinning.

Moreover, in a situation in which the fine powder removal step is performed to remove fine powder from silver powder after the first surface smoothing step has been performed, and then the second surface smoothing step is further performed as described above, a silver powder that has a large volume-based median diameter and a small specific surface area does experience surface smoothing, but tends to have a smaller amount of change of surface roughness compared to a silver powder that has a small volume-based median diameter and a large specific surface area. Therefore, it is preferable to adopt a silver powder that when a value for the product of the arithmetic average roughness of surfaces in surface roughness measurement of a 500 nm×500 nm area multiplied by the volume-based median diameter is calculated, yields a product of 12,000 nm² or less.

### BRIEF DESCRIPTION OF THE DRAWINGS

In the accompanying drawings:

FIG. 1 is a schematic diagram of a production process for implementing a method of producing a silver powder according to a present embodiment;

FIG. 2 is a schematic diagram for describing reattachment of scraps in a first surface smoothing step;

FIG. 3 is a schematic diagram for describing separation of scraps in a fine powder removal step;

FIG. 4 is an SEM image (×50,000 magnification) of a fine silver particle in a silver powder of Example 2;

FIG. 5 is an SEM image (×10,000 magnification) of fine silver particles in the silver powder of Example 2;

FIG. 6 is an SEM image of cross-sections of fine silver particles in the silver powder of Example 2;

FIG. 7 illustrates 2D data for a fine silver particle in the silver powder of Example 2;

FIG. 8 is an SEM image (×10,000 magnification) of fine silver particles in a silver powder of Comparative Example 1;

FIG. 9 illustrates 2D data for a fine silver particle in the silver powder of Comparative Example 1;

FIG. 10 illustrates the shape of an electrode pattern for performing thin wire evaluation;

FIG. 11 is a table of photographs illustrating an energization state of an electrode during thin wire evaluation in Examples 1 and 2 and Comparative Examples 1, 2, and 3;

FIG. 12 is a table of photographs illustrating an energization state of an electrode during thin wire evaluation in Examples 3 and 4 and Comparative Examples 4 and 5;

FIG. 13 is an error signal image in surface roughness measurement of fine silver particles in a silver powder of Example 1;

FIG. 14 is a topographic image in surface roughness measurement of fine silver particles in the silver powder of Example 1;

FIG. 15 is a surface roughness image for a 500 nm×500 nm area in surface roughness measurement of fine silver particles in the silver powder of Example 1;

FIG. 16 is an error signal image in surface roughness measurement of fine silver particles in the silver powder of Comparative Example 1;

FIG. 17 is a topographic image in surface roughness measurement of fine silver particles in the silver powder of Comparative Example 1; and

FIG. 18 is a surface roughness image for a 500 nm×500 nm area in surface roughness measurement of fine silver particles in the silver powder of Comparative Example 1.

### DETAILED DESCRIPTION

The following describes a silver powder and method of producing the same according to an embodiment of the present disclosure based on the drawings.

(Description of Overall Configuration)

The silver powder according to the present embodiment contains fine silver particles having internal voids and having surfaces with an arithmetic average roughness of 3 nm or less. Such a silver powder is realized through the method of producing a silver powder according to the present embodiment.

The method of producing a silver powder according to the present embodiment includes: a first surface smoothing step of causing fine silver particles having internal voids to mechanically collide with one another; a fine powder removal step of dispersing fine silver particles present after the first surface smoothing step using high-pressure airflow while removing fine powder; and a second surface smoothing step of causing fine silver particles present after the fine powder removal step to mechanically collide with one another. Note that the term “surface smoothing” as used in the present embodiment refers to smoothing of surface irregularities of fine silver particles. The concept of surface smoothing encompasses a concept of spheroidization of particles and a concept of reduction of specific surface area. In the following description, an operation or process of smoothing the surfaces of fine silver particles may also be referred to simply as smoothing or the like. In particular, smoothing performed in the first surface smoothing step may also be referred to as a first surface smoothing process and smoothing performed in the second surface smoothing step may also be referred to as a second surface smoothing process. The silver powder (feedstock silver powder L) that contains fine silver particles having internal voids preferably has an apparent density of 9.8 g/cm³ or less. Moreover, a silver powder that is obtained through the method of producing a silver powder according to the present embodiment preferably also has internal voids and an apparent density of 9.8 g/cm³ or less.

The method of producing a silver powder according to the present embodiment may further include a coarse powder classification step of removing coarse powder using a sieve or a centrifugal classifier after the second surface smoothing step.

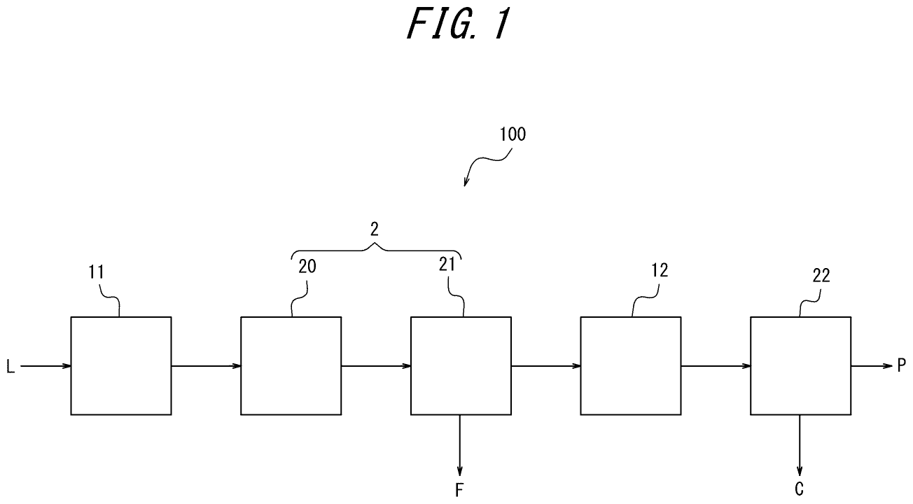

FIG. 1 illustrates a schematic diagram of a production process 100 for implementing the method of producing a silver powder according to the present embodiment. As one example, the production process 100 includes a first smoothing device 11 that implements the first surface smoothing step, a fine powder removal system 2 that implements the fine powder removal step, a second smoothing device 12 that implements the second surface smoothing step, and a coarse powder classifying device 22 that implements the coarse powder classification step.

Silver powder (feedstock silver powder L) that contains fine silver particles having internal voids is supplied to the first smoothing device 11. Silver powder that has undergone smoothing of particle surfaces in the first smoothing device 11 is further supplied to the fine powder removal system 2. In the fine powder removal system 2, fine powder F including scraps produced in the first smoothing device 11 is removed. In the fine powder removal system 2, high-pressure airflow causes progression of dispersion of agglomerates of fine silver particles that have formed in the first smoothing device 11 (i.e., an operation of breaking up agglomerates).

Silver powder that has been processed in the fine powder removal system 2 is supplied to the second smoothing device 12. In the second smoothing device, it is possible to perform smoothing until the surfaces of fine silver particles have an arithmetic average roughness of 3 nm or less.

In this manner, the method of producing a silver powder according to the present embodiment enables production of the silver powder according to the present embodiment (i.e., a silver powder containing fine silver particles that have internal voids and have surfaces with an arithmetic average roughness of 3 nm or less).

Silver powder that has been processed in the second smoothing device 12 may be further supplied to the coarse powder classifying device 22. In the coarse powder classifying device, coarse particles that were contained in the feedstock silver powder L, agglomerates that have formed in the first surface smoothing step and have not been completely dispersed in the fine powder removal step, and agglomerates that have formed in the second surface smoothing step are removed as coarse powder C, thereby producing a silver powder with a controlled particle size distribution (product silver powder P in one example). This silver powder is subjected to other necessary processing (surface treatment or mixing with other ingredients) as required and then serves as a filler of a conductive paste. Note that the silver powder according to the present embodiment is normally produced with a volume-based median diameter of not less than 1.0 μm and not more than 4.0 μm. The silver powder is preferably produced with a volume-based median diameter of not less than 1.3 μm and not more than 3.0 μm.

A conductive paste that contains the silver powder according to the present embodiment as a filler is advantageous in low-temperature firing (i.e., enables low-temperature firing) due to the presence of internal voids. Moreover, as a result of the surfaces of the fine silver particles having undergone smoothing, the conductive paste has low susceptibility to wire disconnection even upon wire thinning.

### DETAILED DESCRIPTION

The silver powder according to the present embodiment contains fine silver particles having internal voids and having surfaces with an arithmetic average roughness Ra of 3 nm or less. Such a silver powder is advantageous in low-temperature firing and has low susceptibility to disconnection as previously described.

The fine silver particles contained in the silver powder according to the present embodiment are preferably spherical particles. This reduces volume resistivity after firing of a paste and results in a product that is preferable as a wire.

Measurement of the arithmetic average roughness Ra of the surfaces of fine silver particles can be performed based on particle images obtained using a scanning electron microscope (SEM). In the present embodiment, an SEM (JSM-7900F) produced by JEOL Ltd. can be used, and a value that is calculated using accompanying measurement software (3D construction software) can be adopted. In this case, SEM images of fine silver particles are captured from four directions. The magnification during image capture is set as ×50,000. Accompanying measurement software (SMILE VIEW) can then be used to create 3D reconstruction data (3D topographic data), and measurement (calculation) can be performed based on this data. In more detail, information (hereinafter, referred to as 2D data) relating to an external shape (contour) of a particle corresponding to when the particle is sectioned is determined based on the 3D reconstruction data described above, and then a roughness curve is measured with a Gaussian filter set to a specific value. The arithmetic average roughness (Ra) is then calculated for this roughness curve based on JIS B 0601. As one example, the specific value for the Gaussian filter may be set as 250 nm.

Measurement of the arithmetic average roughness Sa of the surfaces of silver particles can be performed based on topographic images obtained using a scanning probe microscope (SPM). In the present embodiment, acquisition of a topographic image and calculation of Sa can be performed using an SPM (Nano Cute) produced by SIT NanoTechnology Inc. In more detail, the arithmetic average roughness Sa of a particle surface can be calculated by specifying an area in which roughness is to be analyzed with respect to a topographic image acquired using the SPM, and then performing third-order tilt correction and flattening processing so as to remove a component originating from a curved surface of the particle. As one example, the area that is to be analyzed may be set as a square area having a side length of 500 nm.

The term “spherical” used in relation to a fine silver particle means that a major axis and a minor axis of the fine silver particle have an aspect ratio (value determined by dividing the major axis by the minor axis) of less than 2. The term “spherical silver powder” refers to a silver powder containing fine silver particles that have an average aspect ratio of less than 2.

With regards to the aspect ratio of a fine silver particle, the major axis and the minor axis may be determined from an SEM image. The major axis and the minor axis are calculated based on an image of the fine silver particle in which the shape of the perimeter of the particle can be confirmed. Note that when an image of the particle is sandwiched between parallel lines, the major axis is equal to the distance between the parallel lines at a position where the distance between the parallel lines is largest. Moreover, when an image of the particle is sandwiched between parallel lines, the minor axis is equal to the distance between the parallel lines at a position where the distance between the parallel lines is smallest.

In production of the silver powder according to the present embodiment, a silver powder that contains fine silver particles having voids is used. As one example, such a silver powder can be produced by a wet reduction method described below. In the following description, a silver powder that can serve as a feedstock for producing the silver powder according to the present embodiment may also be referred to simply as a feedstock silver powder. Moreover, fine silver particles having voids that are contained in the feedstock silver powder may also be referred to simply as feedstock particles.

As one example, the feedstock silver powder is produced by the following wet reduction method as previously mentioned. The wet reduction method is a method in which an alkali or complexing agent is added to a silver salt-containing aqueous solution to produce a silver oxide-containing slurry or a silver complex salt-containing aqueous solution, and then a reductant such as formalin is added to cause reduction precipitation of silver powder. In the following description, this method is also referred to simply as the wet reduction method. Moreover, the fine silver particles may also be referred to simply as particles. Note that a silver powder is a powder of silver and is a collection of fine silver particles. When referring simply to a silver powder in the following description, this may also encompass a connotation of a collection of fine silver particles and a connotation of fine silver particles.

Ultrasound or the like may be imparted during reduction precipitation in the wet reduction method, and adjustment of the state of reduction precipitation makes it possible to obtain a silver powder containing fine silver particles that have internal voids.

In the wet reduction method, it is necessary to prevent agglomeration of fine silver particles and obtain monodisperse fine silver particles. The wet reduction method can include processing of adding a dispersant to a silver slurry resulting from reduction precipitation or processing of adding a dispersant to an aqueous reaction system containing at least one of a silver salt and silver oxide prior to causing reduction precipitation of fine silver particles with the aim of obtaining monodisperse fine silver particles. One or more selected from fatty acids, fatty acid salts, surfactants, organic acids such as amino acids, organometallics, chelating agents, and protective colloids can be used as the dispersant.

The following describes a case in which the feedstock silver powder and feedstock particles are produced by the wet reduction method described above. The feedstock particles include voids that are connected to the outside of the particles (also referred to as pores) and also includes internal voids that are closed spaces that are not connected to the outside of the particles.

Note that it is not essential that pores are present at the surfaces of the fine silver particles after the subsequently described surface smoothing is performed. When surface smoothing is performed, this may result in pores no longer being observed at surfaces of the fine silver particles. Internal voids remain even when surface smoothing is performed. Note that the internal voids may have any size and shape.

Confirmation of internal voids in fine silver particles and feedstock particles can be performed through resin embedding, sectioning, polishing, and particle cross-section SEM observation of these particles. In more detail, these particles are embedded in resin. The embedded particles are then sectioned together with the resin in which the particles are embedded so as to expose particle cross-sections. The sectioned surface is then polished. The polished cross-sections of the fine silver particles are then observed using an SEM. The magnification during SEM observation is preferably set as ×10,000 or higher.

The following describes the density of the fine silver particles and feedstock particles. Silver has a density of 10.49 g/cm³. The density measured by what is referred to as a pycnometer method is the measured apparent density. In other words, in measurement by this method, the apparent volume of the particles, which does not exclude pores and internal voids thereof, is taken as the volume of the particles serving as a basis for measurement. Consequently, in the case of fine silver particles having internal voids, the apparent volume of the particles, which is larger than the true volume (volume excluding volume of pores and internal voids), is used as the volume of the particles serving as a basis for density measurement by this method. This means that the density of the fine silver particles and feedstock particles that can be measured by the pycnometer method is less than 10.49 g/cm³.

The following describes the first surface smoothing step. In the first surface smoothing step, a surface smoothing process of causing fine silver particles to mechanically collide with one another to smooth surfaces of the fine silver particles is performed. This causes a certain degree of smoothing of surfaces of the fine silver particles. As one example, a silver powder produced by the wet reduction method is subjected to the first surface smoothing step. The silver powder that is subjected to the first surface smoothing step has preferably been subjected to a drying process in advance to ensure suitable fluidity.

The first smoothing device 11 that implements the first surface smoothing step is preferably a device that can mechanically fluidize silver powder.

The first smoothing device 11 can, for example, be a high-speed stirring-type mixer, a surface modification-type mixer, a mill that can also be used for powder milling, or a particle surface treatment device having the same function as such a mill that strongly fluidizes silver powder through a rotating stirring blade (hereinafter, referred to simply as a rotating blade) or a rotating rotor (one example of a rotating blade) that rotates at high speed. The first smoothing device 11 can process (smooth) the surfaces of the fine silver particles to a smooth shape by fluidizing silver powder, causing the fine silver particles to collide with one another, and rubbing the fine silver particles together (imparting shear force). As one example, the first smoothing device 11 may be a device such as a cylindrical mixer or a Sample Mill (SK-10 produced by Kyoritsu Riko) having a rotating blade at the bottom thereof. Such a device has a rotating blade that fluidizes silver powder, and the device rotates the rotating blade at high-speed and imparts high shear force while implementing collisions between fine silver particles.

In the smoothing process in the first smoothing device 11, processing is preferably performed such that the cumulative power imparted per 1 kg of silver powder is not less than 10 Wh/kg and not more than 300 Wh/kg. Processing is more preferably performed such that the cumulative power is not less than 50 Wh/kg and not more than 200 Wh/kg. Power imparted to the silver powder and cumulative power imparted to the silver powder are described below. The rotation speed of the rotating blade and the processing time in the first smoothing device 11 should be arbitrarily set such that power is imparted to the silver powder as described above. When the cumulative power imparted to the silver powder is excessively large, it may not be possible to achieve sufficient smoothing due to scraps that are produced. Moreover, agglomeration of the silver powder may occur.

The power imparted to the silver powder is a value obtained when the energy consumed by the first smoothing device 11 in a situation in which the rotating blade is caused to rotate in the same manner as during the smoothing process in a state in which silver powder is not loaded into the device is subtracted from the power of the first smoothing device 11 during the smoothing process using the first smoothing device 11. In the present embodiment, a value obtained when the power of a motor of the first smoothing device 11 in a situation in which the rotating blade is caused to rotate in the same manner as in the smoothing process in a state in which silver powder is not loaded (also referred to as empty operation) is subtracted from the power of the motor of the first smoothing device 11 during the smoothing process may be adopted as the power that is imparted to the silver powder.

The cumulative power imparted to the silver powder is a value obtained by integrating by time for the power that is imparted to the silver powder. In other words, the cumulative power (Wh/kg) imparted per 1 kg of the silver powder is a value obtained when the cumulative power (Wh) imparted to the silver powder loaded into the first smoothing device 11 is divided by the amount (kg) of the silver powder that is loaded into the first smoothing device 11.

In the present embodiment, electric power consumed by the motor may be adopted as the power of the motor of the first smoothing device 11. A value obtained through measurement using a wattmeter that is built into a control panel or inverter driving the motor may be adopted as the electric power consumption of the motor. Moreover, a value that is calculated based on a current value and the like obtained through measurement of a current value, voltage, and power factor for current supplied to the motor may be adopted as the electric power consumption of the motor of the first smoothing device 11. For example, in a case in which current supplied to the motor is three-phase AC current, the electric power consumption (W) of the motor can be calculated by multiplying the current value (A) by the voltage (V) and the power factor (−) and then further multiplying by √3. In a case in which the current supplied to the motor is single-phase, the electric power consumption (W) of the motor can be calculated by multiplying the current value (A) by the voltage (V) and the power factor (−).

The powder concentration inside of the first smoothing device 11 is preferably set as not less than 100 kg/m³ and not more than 500 kg/m³. By setting a powder concentration such as set forth above, agglomeration can be inhibited while also causing efficient progress of smoothing. Note that the powder concentration inside of the first smoothing device 11 is a value obtained when the mass (kg) of silver powder loaded to the inside (processing tank for silver powder or processing space inside device) of the first smoothing device 11 is divided by the effective volume (m³; volume excluding volume of rotating blade, etc.) of the inside of the first smoothing device 11.

The following describes the fine powder removal step. Silver powder present after the first surface smoothing step is subjected to the fine powder removal step. The fine powder removal step is a step of dispersing the fine silver particles using high-pressure airflow while removing fine powder. This causes progression of smoothing of the fine silver particles and can promote smoothing in the subsequently described second surface smoothing step.

The fine powder removal step may include: a separation and dispersion step of causing the fine silver particles to flow while continuously dispersing the fine silver particles using high-pressure airflow and separating the fine powder from the fine particles; and a fine powder classification step of classifying the fine silver particles that have undergone the separation and dispersion step to remove the fine powder.

The fine powder removal system 2 that implements the fine powder removal step may be a device including a separating and dispersing mechanism that causes the fine silver particles to flow while continuously dispersing the fine silver particles using high-pressure airflow and that separates fine powder from the fine particles and a classifying mechanism that removes the fine powder from the silver powder, or may be a system in which two or more devices including these mechanisms are connected.

As one example, the fine powder removal system 2 may have a configuration including: a separating and dispersing device 20 that includes a separating and dispersing mechanism for causing the fine silver particles to flow while continuously dispersing the fine silver particles using high-pressure airflow and for separating fine powder from the fine particles; and a fine powder removal device 21 that includes a classifying mechanism for removing the fine powder from the silver powder.

FIG. 1 illustrates a case in which the fine powder removal system 2 uses the separating and dispersing device 20 to separate fine powder from the fine silver particles and then uses the fine powder removal device 21 to remove, from the silver powder, fine powder F that has been separated from the fine silver particles.

Specific examples of the separating and dispersing device 20 include a single track jet mill (produced by Seishin Enterprise Co., Ltd.), a super jet mill (produced by Nisshin Engineering Inc.), and a spiral jet mill (produced by Hosokawa Micron Corporation) that implement an operation of colliding the fine silver particles with one another in swirling flow generated by causing the fine silver particles to flow while continuously supplying high-pressure airflow (normally using compressed air); and an opposed jet mill (produced by Hosokawa Micron Corporation) and a cross jet mill (produced by Kurimoto, Ltd.) that have a built-in classifying rotor and that implement an operation of colliding the fine silver particles with one another by suppling high-speed air flows into a fluidized bed of fluidized fine silver particles from a plurality of supply holes such that the high-speed airflows collide.

The supply of compressed air to the silver powder in the separating and dispersing device 20 causes collisions and abrasion of the fine silver particles. This causes scraps (fine powder) formed in the first surface smoothing process and scraps (fine powder) newly formed through collisions and abrasion of the fine silver particles inside the fine powder removal system 2 to separate from the surfaces of the fine silver particles. The supply of compressed air to the silver powder in the separating and dispersing device 20 can also break up agglomerates of the fine silver particles. In the following description, fine powder produced through scraping of the surfaces of fine silver particles may be referred to collectively as scraps. The concept of scraps encompasses fine powder produced in the first surface smoothing process.

In the separating and dispersing device 20, processing is preferably performed under conditions such that the supplied amount (airflow rate) of compressed air supplied per processing of 1 kg of silver powder is 1 m³ or more (normal-equivalent supplied amount). The supply pressure of the high-pressure airflow (pressure applied to a milling nozzle) should be not less than 0.2 MPa and not more than 1.0 MPa, and preferably not less than 0.5 MPa and not more than 0.9 MPa.

One example of the classifying mechanism is a pneumatic classifier. A specific example of a pneumatic classifying mechanism is a mechanism that utilizes centrifugal force or inertial force in airflow. Specifically, one example is a classifying mechanism that performs classification through the balance between the centrifugal force caused by swirling flow generated through supply of airflow and the force of airflow flowing in a direction against the centrifugal force. Moreover, another example is a classifying mechanism that performs classification through the balance between the centrifugal force generated through a rotating rotor and the force of airflow flowing in a direction against the centrifugal force. Yet another example is a classifying mechanism that performs classification through the balance between the inertial force of flying particles and the force generated through bending airflow.

Specific examples of the fine powder removal device 21 include an Aerofine Classifier (produced by Nisshin Engineering Inc.) and a cyclone, which implement classification using centrifugal force due to a free vortex or semi-free vortex generated through supply of high-speed airflow, an Elbow-Jet (produced by Matsubo Corporation), which utilizes inertial force of particles accelerated by high-speed airflow, and a T-Plex (produced by Hosokawa Micron Corporation), which utilizes centrifugal force generated through a rotating rotor.

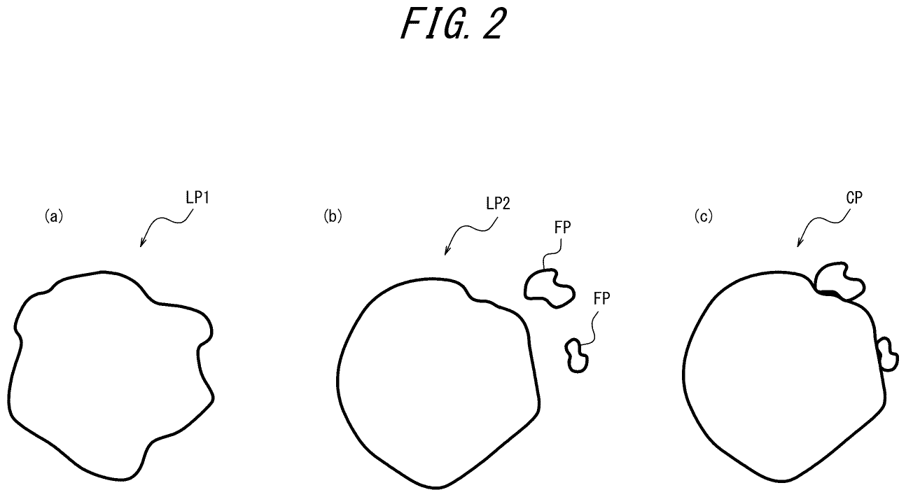

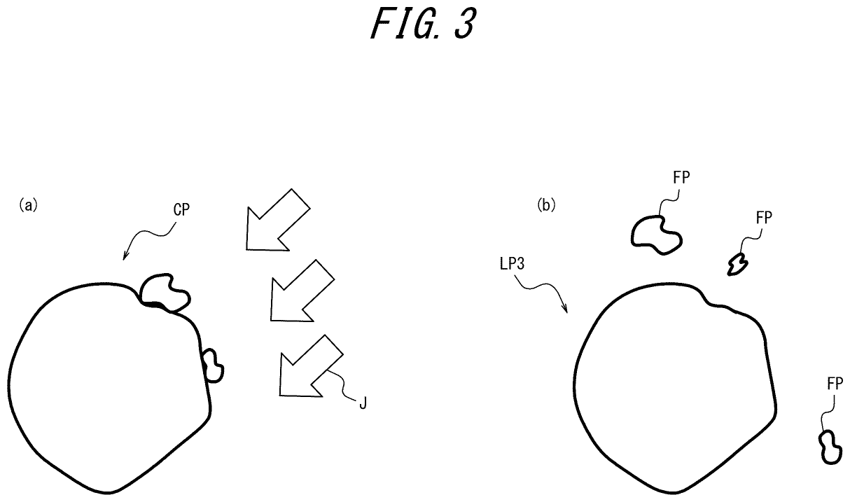

The following provides a supplementary description of processing from the first surface smoothing step up to the fine powder removal step and of a relationship between the fine powder removal step and the subsequently described second surface smoothing step with reference to FIG. 2 and FIG. 3. Feedstock particles LP1 are particles having large irregularities at the surfaces thereof (refer to (a) in FIG. 2). Collisions between such feedstock particles LP1 in the first surface smoothing step cause the feedstock particles LP1 to become intermediate particles LP2 having surfaces that have undergone a certain degree of smoothing and produce scraps FP as fine powder formed through collisions (refer to (b) in FIG. 2). However, in a situation in which scraps FP remain inside a processing space where collisions occur, the scraps FP may reattach to intermediate particles LP2 to form agglomerate particles CP. For this reason, the fine powder removal step is adopted between the first surface smoothing step and the second surface smoothing step so as to remove scraps from the silver powder and then subject the silver powder to the second surface smoothing step.

In the fine powder removal step, dispersing force is imparted to the agglomerate particles CP using high-pressure airflow J ((a) in FIG. 3) and scraps FP are separated from the agglomerate particles CP ((b) in FIG. 3) through the separation and dispersion step. During the above, the surfaces of the agglomerate particles CP may be further smoothed through dispersing force of the high-pressure airflow J (i.e., scraps may be produced). Intermediate particles LP3 (silver powder) present after separation of scraps FP are subjected to the subsequently described second surface smoothing step.

The following describes the second surface smoothing step. Silver powder present after the fine powder removal step is subjected to the second surface smoothing step. In the second surface smoothing step, a surface smoothing process of causing fine silver particles to mechanically collide is continued. This causes further smoothing of surfaces of the fine silver particles.

The second smoothing device 12 that implements the second surface smoothing step is preferably a device that can mechanically fluidize silver powder. The second smoothing device 12 may be the same device as the first smoothing device 11 or may be the same type or model of device as the first smoothing device 11. Note that in a case in which the second smoothing device 12 is the same device as the first smoothing device 11, this means that silver powder present after the fine powder removal step is reloaded into the first smoothing device 11 that was used in the first surface smoothing step.

With regards to the second smoothing device 12, progression of smoothing in the first surface smoothing step plateaus (i.e., a state in which smoothing does not progress is reached) in a comparatively short time due to the presence of scraps (fine powder) produced through the first surface smoothing process. In contrast, in the second surface smoothing step, scraps have been removed in advance through the fine powder removal step. Moreover, irregularities that can potentially become scraps that impair progression of smoothing are on the whole removed from the surfaces of the fine silver particles through the first surface smoothing process. Consequently, it is possible to suppress impairment of the smoothing process by scraps and cause progression of smoothing in the second surface smoothing step.

The second smoothing device 12 preferably performs processing such that the cumulative power imparted per 1 kg of silver powder is 60 Wh/kg or more.

The coarse powder classification step is a step of performing classification of removing coarse particles arising in the second surface smoothing step. The coarse powder classifying device 22 used in the coarse powder classification step is preferably a device that implements a classification method enabling removal of coarse particles without loss of surface smoothness.

It is not essential for the coarse powder classifying device 22 to perform processing of causing collisions and abrasion of particles as in the fine powder removal system 2. A device having desired classification characteristics can be selected as appropriate as the coarse powder classifying device 22 from among various types of classifying devices that are based on principals of gravity, inertia, centrifugal force, and so forth, for example. As one example, the desired classification characteristics may be the size of particles that can be removed, the processing rate, and the yield.

The coarse powder classifying device 22 may, for example, be a dry vibratory sieve or in-plane sifting device, or a pneumatic classifier. Note that in the case of a dry vibratory sieve or in-plane sifting device, it is preferable to adopt a sieve mechanism having a structure that causes the powder to pass through a screen of a certain size (opening size of 10 μm to 45 μm as one example). In a case in which a pneumatic classifier is used, it is preferable to adopt a device that is suitable for setting a coarse powder cutting point of from μm to 45 μm.

The silver powder according to the present embodiment can be obtained as set forth above.

The following describes examples of the silver powder according to the present embodiment.

### Example 1

A silver powder according to Example 1 was produced as follows.

Industrial-use ammonia was added in an amount of 3.8 L to 70 L of silver nitrate solution, which was 10 g/L in terms of silver ions, to produce a silver ammine complex solution. The pH of this silver ammine complex solution was adjusted through addition of 100 g of sodium hydroxide, and then 5 L of industrial-use formalin was added as a reductant. Straight thereafter, 100 g of a stearic acid emulsion containing 2 g of stearic acid was added to obtain a silver slurry. This silver slurry was filtered and washed with water, and was subsequently dried in a vacuum dryer for 500 minutes to yield a silver powder (feedstock silver powder). Fine silver particles (feedstock particles) in the obtained silver powder had internal voids.

The feedstock silver powder was subjected to a first surface smoothing step. In the first surface smoothing step, the feedstock silver powder was loaded into a sample mill (SK-10 produced by Kyoristu Riko) serving as a first smoothing device, the powder concentration inside of the device was set to 300 kg/m³, and 8 minutes of processing was performed until the cumulative power imparted per 1 kg of silver powder reached 156 Wh/kg.

Silver powder present after the first surface smoothing step was further subjected to a fine powder removal step. In the fine powder removal step, a separation and dispersion step was performed using a separating and dispersing device (Jet Mill CJ-25 produced by Nisshin Engineering Inc.) under a condition of the supplied amount of compressed air (0.6 MPa) being 8 m³ per 1 kg of silver powder. This condition is known to provide an effect of breaking up agglomerates of fine silver particles that are larger than 8 μm in addition to separating fine particles as scraps.

In the fine powder removal step, a fine powder classification step was performed using a fine powder removal device (typical cyclone) with the amount of air used in pneumatic conveyance set as 18 m³ per 1 kg of silver powder. This condition caused fine particles (scraps) that were smaller than 0.1 μm to be removed from the silver powder and be discharged out of the system from an exhaust port of the cyclone.

Silver powder present after the fine powder removal step was subjected to a second surface smoothing step. In the second surface smoothing step, a second surface smoothing process was performed under the same conditions as in the first surface smoothing step.

Silver powder present after the second surface smoothing step was subjected to a coarse powder classification step. In the coarse powder classification step, coarse particles were removed using sieve to thereby complete production of the silver powder of Example 1.

### Example 2

A silver powder according to Example 2 was produced under the same conditions as in Example 1 with the exception that in the processing conditions of the first surface smoothing step in Example 1, 4 minutes of processing was performed until the cumulative power imparted per 1 kg of silver powder reached 75 Wh/kg, and that in the fine powder removal step, the amount of compressed air that was supplied per 1 kg of silver powder in the separation and dispersion step was set as 2.5 m³ and the amount of air that was used in pneumatic conveyance per 1 kg of silver powder in the fine powder classification step was set as 6 m³.

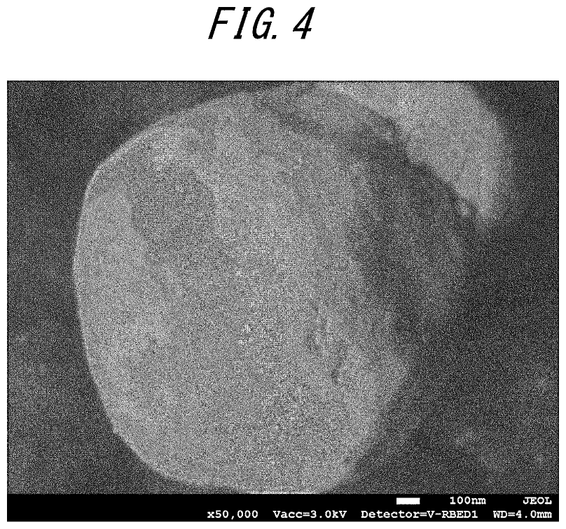

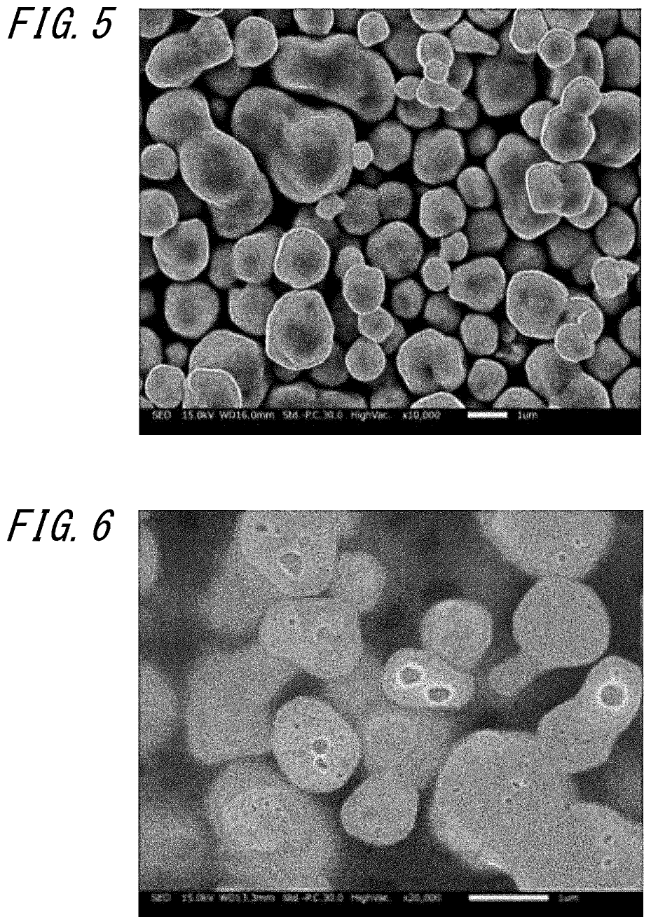

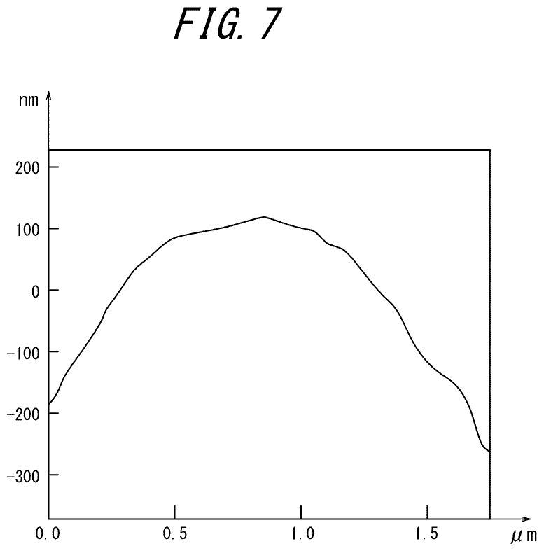

SEM images of fine silver particles (fine silver particles that were measurement subjects for arithmetic average roughness) in the silver powder of Example 2 are presented in FIGS. 4 to 6. The SEM image presented in FIG. 4 has a magnification of ×50,000. The SEM image presented in FIG. 5 has a magnification of ×10,000. FIG. 6 is an SEM image illustrating cross-sections of fine silver particles in the silver powder of Example 2 and has a magnification of ×20,000. Moreover, an example of 2D data determined from the ×50,000 SEM image in FIG. 4 is illustrated in FIG. 7. The horizontal axis of the graph in FIG. 7 is the distance on a flat plane in a top surface view of a particle that is an extraction subject of the 2D data and is the distance in a direction along the cross-section that is an extraction subject of the 2D data. Moreover, the vertical axis of the graph in FIG. 7 is the elevation (height or depth) from a reference point at the particle surface in the cross-sectional part that is an extraction subject for the 2D data. It can be seen from a glance at the SEM image in FIG. 5 that the aspect ratios of fine silver particles in the silver powder in Example 2 are less than 2 when an overall average thereof is taken.

A silver powder according to Example 3 was produced under the same conditions as in Example 1 with the exception that in the production conditions of the feedstock silver powder in Example 1, the amount of sodium hydroxide was changed to 360 g when performing pH adjustment and the amount of the stearic acid emulsion that was added was changed to 220 g, that in the processing conditions of the first surface smoothing step, 4 minutes of processing was performed until the cumulative power imparted per 1 kg of silver powder was 75 Wh/kg, and that in the processing conditions of the second surface smoothing step, 10 minutes of processing was performed until the cumulative power imparted per 1 kg of silver powder reached 187 Wh/kg.

A silver powder according to Example 4 was produced under the same conditions as in Example 1 with the exception that in the production conditions of the feedstock silver powder in Example 1, the amount of sodium hydroxide was changed to 60 g when performing pH adjustment, that in the processing conditions of the first surface smoothing step, 10 minutes of processing was performed until the cumulative power imparted per 1 kg of silver powder was 190 Wh/kg, and that in the processing conditions of the second surface smoothing step, 10 minutes of processing was performed until the cumulative power imparted per 1 kg of silver powder reached 190 Wh/kg.

### Comparative Example 1

A silver powder according to Comparative Example 1 was produced under the same conditions as in Example 1 with the exception that in the processing conditions of the first surface smoothing step in Example 1, 4 minutes of processing was performed until the cumulative power imparted per 1 kg of silver powder reached 75 Wh/kg, that in the fine powder removal step, the amount of compressed air that was supplied per 1 kg of silver powder in the separation and dispersion step was set as 2.5 m³ and the amount of air that was used in pneumatic conveyance per 1 kg of silver powder in the fine powder classification step was set as 6 m³, and that the second surface smoothing step was not performed.

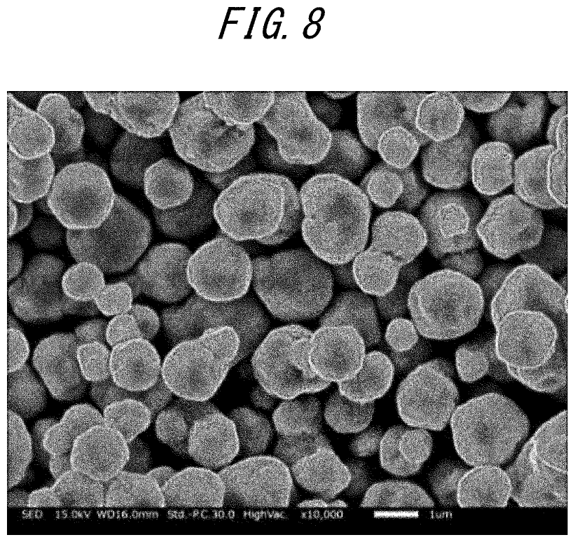

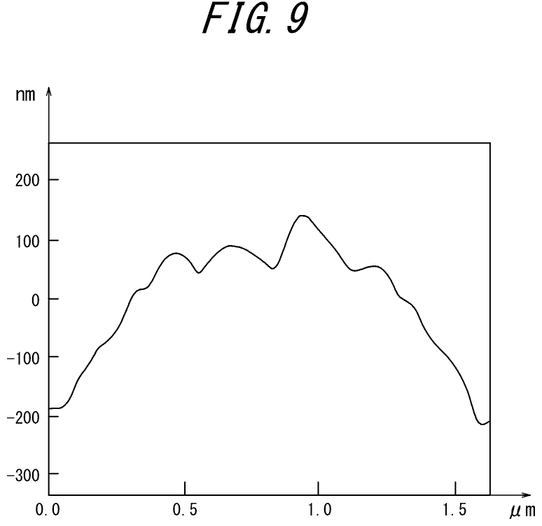

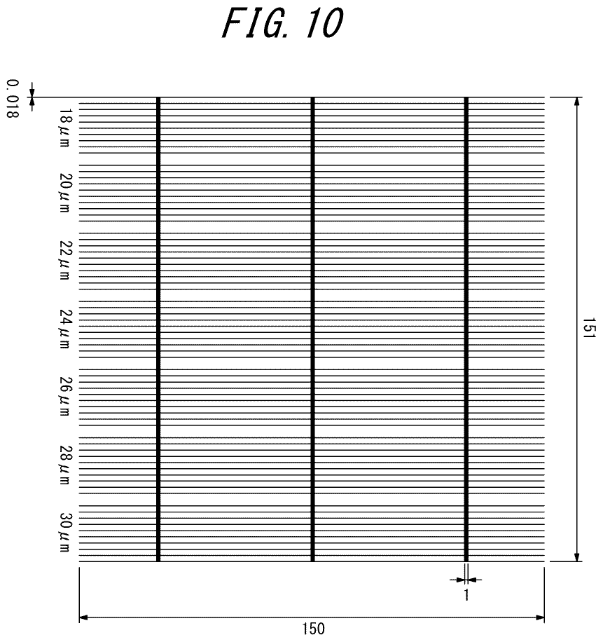

An SEM image of fine silver particles in the silver powder of Comparative Example 1 is presented in FIG. 8. The SEM image presented in FIG. 8 has a magnification of ×10,000. An example of 2D data determined from a ×50,000 SEM image is illustrated in FIG. 9.

### Comparative Example 2

A silver powder of Comparative Example 2 was produced under the same conditions as in Example 1 with the exception that in the processing conditions of the first surface smoothing step in Example 1, 17 minutes of processing was performed until the cumulative power imparted per 1 kg of silver powder reached 315 Wh/kg, that in the fine powder removal step, the amount of compressed air that was supplied per 1 kg of silver powder in the separation and dispersion step was set as 8 m³ and the amount of air that was used in pneumatic conveyance per 1 kg of silver powder in the fine powder classification step was set as 18 m³, and that the second surface smoothing step was not performed.

### Comparative Example 3

A silver powder of Comparative Example 3 was produced under the same conditions as in Example 1 with the exception that in the processing conditions of the first surface smoothing step in Example 1, 4 minutes of processing was performed until the cumulative power imparted per 1 kg of silver powder reached 75 Wh/kg, and that the fine powder removal step and the second surface smoothing step were not performed.

### Comparative Example 4

A silver powder of Comparative Example 4 was produced under the same conditions as the silver powder according to Example 3 with the exception that the second surface smoothing step was not performed.

### Comparative Example 5

A silver powder of Comparative Example 5 was produced under the same conditions as the silver powder according to Example 4 with the exception that the second surface smoothing step was not performed.

The following describes evaluation methods of physical properties of silver powders and fine silver particles in the examples, etc.

<Measurement Method of Specific Surface Area>

The specific surface area of a silver powder was taken to be the BET specific surface area determined by the BET method. The BET specific surface area was measured by the single-point BET method using a BET specific surface area analyzer (Macsorb HM-model 1210 produced by Mountech Co., Ltd.) after performing 10 minutes of deaeration of the inside of the analyzer at 60° C. by passing Ne—N₂ mixed gas (30% nitrogen).

<Measurement Method of Ignition Loss>

The ignition loss (Ig-Loss) of a silver powder was taken to be a value determined as follows. First, 2 g of a silver powder sample was weighed out, was loaded into a magnetic crucible, and was heated to 800° C. Heating at 800° C. was performed for 30 minutes so as to cause sufficient heating until the quantity of the sample was constant. Thereafter, the silver powder sample was cooled and was weighed to determine the post-heating mass (w). The ignition loss (%) was determined by the following equation 1.

Ignition loss (%)=(2−w)/2×100 (Equation 1)

<Measurement Method of Tap Density>

The tap density (TAP) of a silver powder was taken to be a value determined using a tap density measurement device (Density Measuring System SS-DA-2 produced by Shibayama Scientific Co., Ltd.). Measurement of the tap density was performed as follows. A silver powder sample was weighed out in an amount of 30 g, was loaded into a 20 mL test tube, and then tapping was performed 1,000 times with a height of 20 mm. The sample volume (cm³) after tapping was then determined. The tap density (g/cm³) was determined by the following equation.

Tap density (g/cm³)=30/Sample volume after tapping (Equation 2)

<Measurement Method of Particle Size Distribution>

The particle size distribution of a silver powder was taken to be a particle size distribution determined by a laser diffraction/scattering method. In the present embodiment, a particle size distribution that can be measured using a laser diffraction/scattering particle size analyzer (MICROTRAC MT-3300 EXII produced by MicrotracBEL Corp.) was adopted as the particle size distribution of the silver powder.

The particle diameter (D10) corresponding to a volume-based cumulative value of 10%, the particle diameter (D50) corresponding to a volume-based cumulative value of 50%, and the particle diameter (D90) corresponding to a volume-based cumulative value of 90% were taken to be values determined from this particle size distribution. Note that the particle diameter (D50) corresponding to a volume-based cumulative value of 50% is the median diameter.

Measurement of the particle size distribution using the laser diffraction/scattering particle size analyzer was performed as follows. First, 0.1 g of the silver powder was added to and dispersed in 40 mL of isopropyl alcohol (IPA). This dispersing was performed using an ultrasonic homogenizer (produced by NISSEI Corporation; device name: US-150T; 19.5 kHz; tip diameter of 18 mm). The dispersing time was set as 2 minutes. The sample that had undergone dispersing was supplied to the laser diffraction/scattering particle size analyzer, and the particle size distribution was determined using accompanying analysis software.

<Measurement Method of Arithmetic Average Roughness Ra, Etc. In Profile Roughness Measurement>

Arithmetic average roughness Ra, etc. were determined based on particle images obtained using a scanning electron microscope (SEM). Specifically, values calculated using an SEM (JSM-7900F) produced by JEOL Ltd. and accompanying measurement software (3D construction software) were adopted. In more detail, first SEM images of a fine silver particle were captured from diagonally above from 4 directions for the same particle through rotation of a stage. The magnification during image capture was set as ×50,000. Accompanying measurement software (SMILE VIEW) was then used to create 3D reconstruction data (3D topographic data), and the arithmetic average roughness Ra, etc. were measured (calculated) based thereon. Specifically, 2D data for a sectioned particle was extracted based on the 3D reconstruction data, information relating to the outer shape of the particle was determined, and a roughness curve was measured with a Gaussian filter set to 250 nm. The arithmetic average roughness (Ra) was calculated for this roughness curve based on JIS B 0601. In evaluation of the present examples, values for Rq, Rv, Rz, Rc, Rt, Rq, Rsk, and Rku defined in JIS B 0601 were also calculated in addition to the arithmetic average roughness (Ra). The calculated values for the arithmetic average roughness (Ra), etc. were each an average value of values determined from three roughness curves that were each based on 2D data for a different cross-section.

<Measurement Method of Arithmetic Average Roughness Sa, Etc. In Surface Roughness Measurement>

The arithmetic average roughness Sa in surface roughness measurement of silver particle surfaces was determined based on topographic images obtained using a scanning probe microscope (SPM). Specifically, an SPM (Nano Cute) produced by SIT NanoTechnology Inc. was used, and an SI-DF40P2 produced by Hitachi High-Tech Fielding Corporation was used as a cantilever. Tapping mode (DFM) was selected as the measurement mode. In more detail, first Q curve measurement was performed and the cantilever was adjusted. During the above, the resonant frequency was confirmed to be in a range of 200 Hz to 500 Hz and the Q value was confirmed to be in a range of 100 to 1,000. The target vibration amplitude for the cantilever was set as 1 V. Next, the SPM was used to acquire a topographic image and an error signal image for fine silver particles in a viewing field range of 5 μm. The amplitude attenuation rate was automatically set in a range of −0.1 to −0.2 at this time. Moreover, the scanning frequency was set such as to be in a range of 0.6 Hz to 1 Hz. Automatic setting of feedback control parameters was adopted. The number of pixels during topographic image acquisition was 256×256. An area in which roughness was to be analyzed in the topographic image was specified, and then third-order tilt correction and flattening processing were performed so as to remove a component originating from the curved surface of a particle and thereby automatically calculate values for arithmetic average roughness Sa and Sz, Sp, Sv, and Sq of the particle surface defined in ISO 25178. Cut off processing was not performed at this time. The analysis area was set as a square area having a side length of 500 nm (hereinafter, referred to as a 500 nm×500 nm area). In the analysis, 10 particles were randomly selected and analyzed, and an average value was calculated for these particles.

<Measurement Method of Density>

Density was determined by a pycnometer method. Measurement conditions for density were as follows. Isopropyl alcohol was used as an immersion liquid. A pycnometer having a capacity of 50 mL was used. A silver powder was weighed out in an amount of 10 g and was subjected to measurement.

<Production of Paste>

A conductive paste (paste) was produced as follows. A paste was obtained by mixing 89.6 mass % of the silver powder of each example or comparative example, 6.2 mass % of a vehicle for high-speed printing (mixture of terpineol, texanol, and butyl carbitol acetate) as an organic binder, 1.0 mass % of a wax (castor oil), 0.4 mass % of 100 cs dimethylpolysiloxane, 0.2 mass % of triethanolamine, 0.2 mass % of oleic acid, 2.0 mass % of Pb—Te—Bi-based glass frit, and 0.4 mass % of a solvent (mixture of terpineol and texanol) through stirring at 1,400 rpm for 30 seconds using a propeller-less planetary stirring and defoaming device (AR250 produced by Thinky Corporation) and then passing and kneading the mixture through a three-roll mill (80S produced by Exakt Technologies Inc.) with a roll gap of from 100 μm to 20 μm.

<Measurement Method of Paste Viscosity>

The viscosity of the paste was measured using a viscometer 5XHBDV-IIIUC produced by Brookfield Engineering. The measurement conditions were set as follows. A CP-52 was used as a cone spindle. The paste temperature was set as 25° C. The rotation speed and measurement time were set as 5 minutes at 1 rpm (shear rate 2 s⁻¹) and 1 minute at 10 rpm (shear rate 20 s⁻¹).

<Thin Wire Evaluation Method>

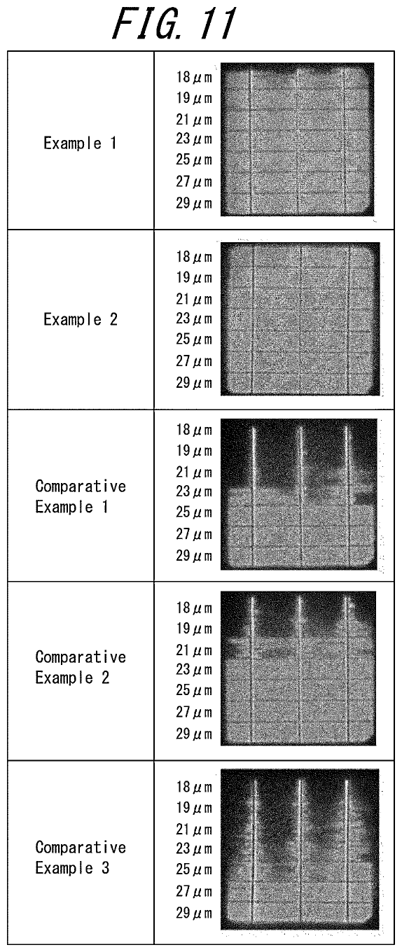

Thin wire evaluation (EL) was performed by forming and evaluating a conduction pattern. Formation of the conduction pattern was performed as described below. First, an aluminum paste (ALSOLAR 14-7021 produced by Toyo Aluminum K.K.) was used to form a 154 mm solid pattern on the rear surface of a silicon substrate (100 Ω/sq.) for a solar cell using a screen printer (MT-320TV produced by Micro-tec Co., Ltd.). Next, the conductive paste was filtered through 500-mesh, and then electrodes (finger electrodes) having line widths of 18 μm to 30 μm and electrodes (busbar electrodes) having a width of 1 mm were printed (applied) with a squeegee speed of 350 mm/s at a front surface-side of the substrate in a pattern illustrated in FIG. 10. After performing 10 minutes of hot-air drying at 200° C., a high-speed firing IR furnace (high-speed firing test four-chamber furnace produced by NGK Insulators, Ltd.) was used to perform firing with a peak temperature of 770° C. and an in-out time of 41 seconds to obtain a conduction pattern. The firing conditions of a peak temperature of 770° C. and an in-out time of 41 seconds constitute what is referred to as low-temperature firing.

After the conduction pattern was obtained, an EL/PL evaluation device (PVX330+POPLI-3C produced by ITES Co., Ltd.) was used to confirm the presence or absence of electrode disconnection. Note that this EL/PL evaluation device performed evaluation by EL (electroluminescence) when current was passed through the busbar electrodes. In a situation in which there is a disconnection of an electrode (finger electrode) between the busbar electrodes, the position where the disconnection has occurred appears black with no emission of light.

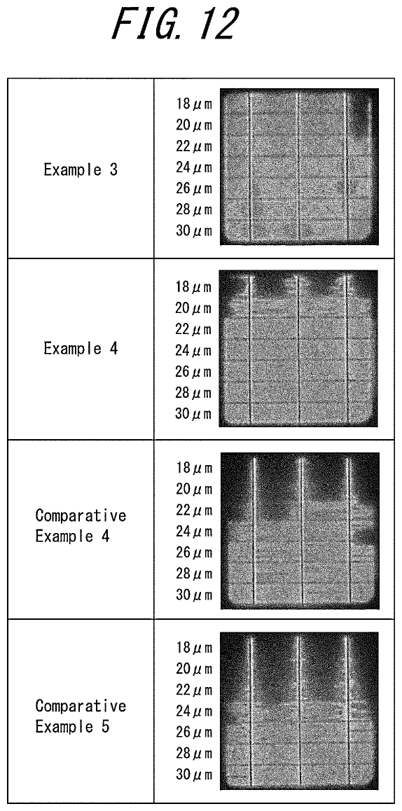

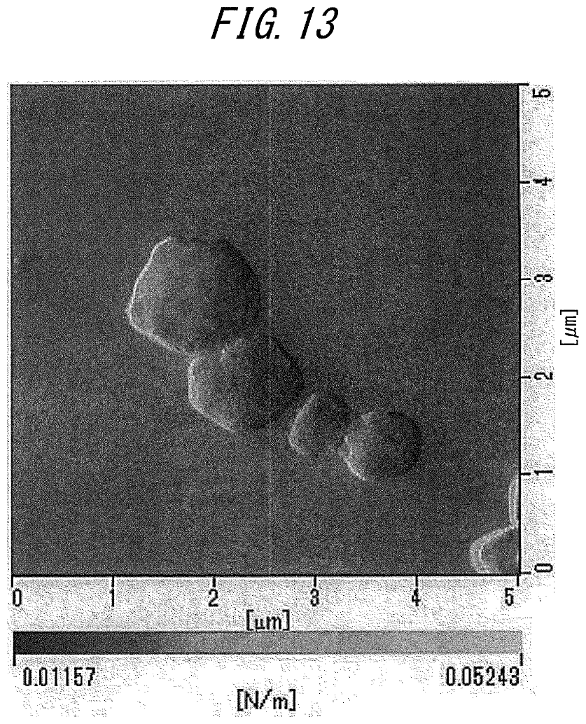

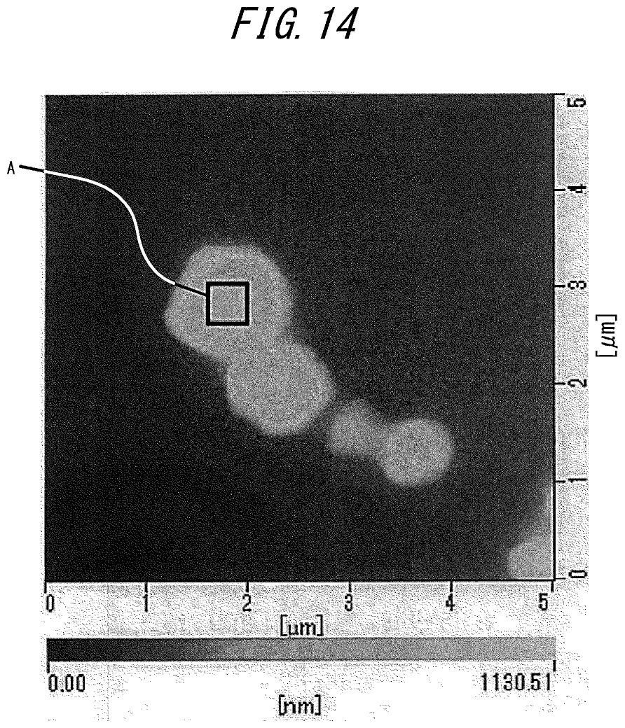

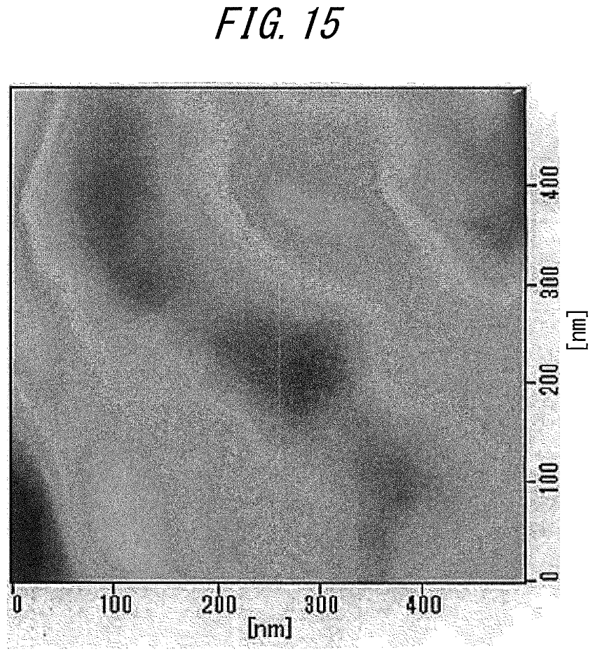

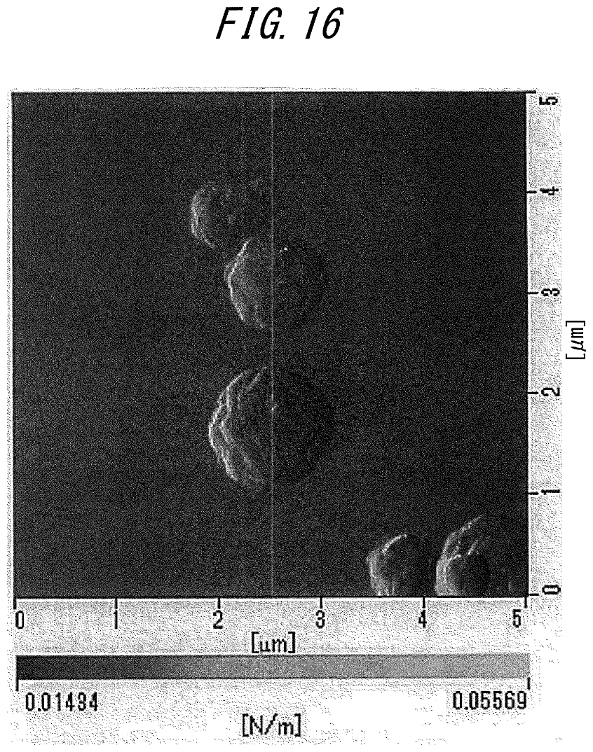

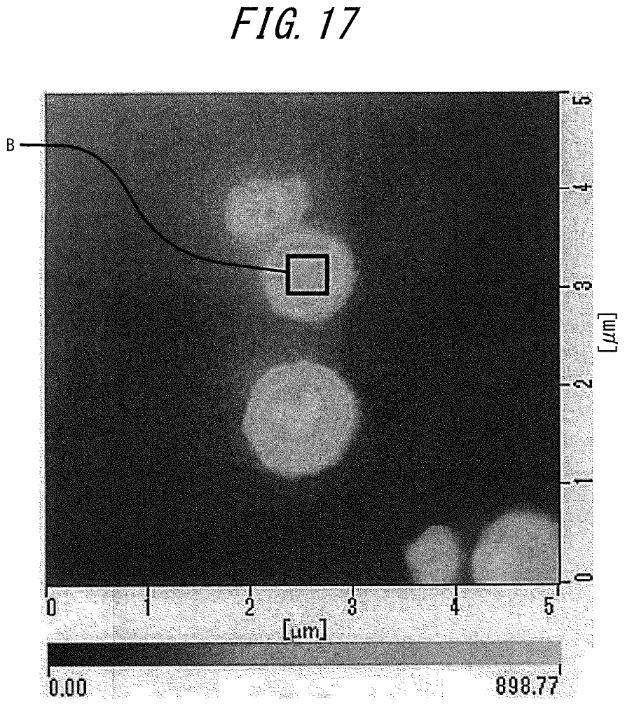

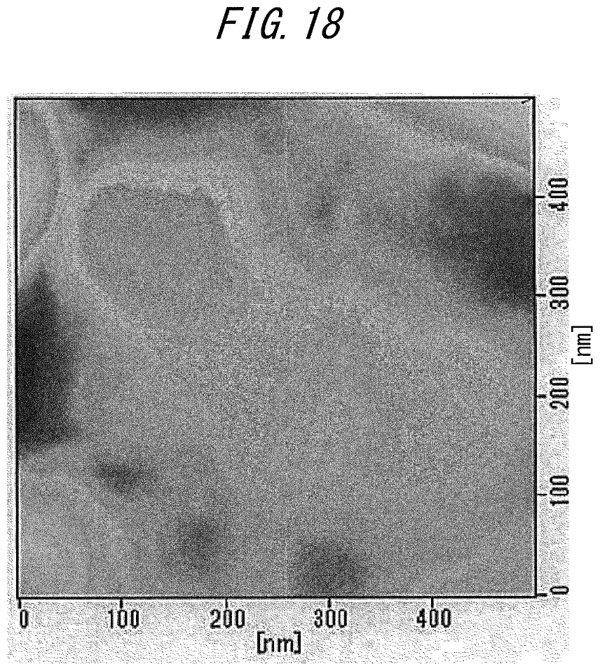

Evaluation results for the silver powders of the examples and comparative examples are shown in Table 1. Photographs presented in FIG. 11 are photographic images illustrating the energization state of electrodes during thin wire evaluation in Examples 1 and 2 and Comparative Examples 1 to 3. Photographs presented in FIG. 12 are photographic images illustrating the energization state of electrodes during thin wire evaluation in Examples 3 and 4 and Comparative Examples 4 and 5. FIGS. 13 to 15 present, in this order, an error signal image, a topographic image, and a surface roughness image for a 500 nm×500 nm area (region A in FIG. 14) in surface roughness measurement of fine silver particles in the silver powder of Example 1. FIGS. 16 to 18 present, in this order, an error signal image, a topographic image, and a surface roughness image for a 500 nm×500 nm area (region B in FIG. 17) in surface roughness measurement of fine silver particles in the silver powder of Comparative Example 1. Data for surface roughness in Example 2 and Comparative Example 1 are shown in Table 2. Moreover, data for surface roughness measurement in Examples 1, 3, and 4 and Comparative Examples 1, 4, and 5 are shown in Table 3.

TABLE 1

| | Production method | | | | | | | |
|---|---|---|---|---|---|---|---|---|
| | First surface | First | Second surface | Second | Powder evaluation results | | | |
| | smoothing | classification | smoothing | classification | SSA | Ig-loss | TAP | D10 |
| | step | step | step | step | m²/g | % | g/cm³ | μm |
| Example 1 | Yes | Yes | Yes | Yes | 0.37 | 0.66 | 6.1 | 1.28 |
| | (156 Wh/kg) | | (156 Wh/kg) | | | | | |
| Example 2 | Yes | Yes | Yes | Yes | 0.43 | 0.66 | 5.8 | 1.19 |
| | (75 Wh/kg) | | (156 Wh/kg) | | | | | |
| Example 3 | Yes | Yes | Yes | Yes | 0.71 | 0.79 | 5.6 | 0.80 |
| | (75 Wh/kg) | | (187 Wh/kg) | | | | | |
| Example 4 | Yes | Yes | Yes | Yes | 0.30 | 0.51 | 5.9 | 1.77 |
| | (190 Wh/kg) | | (190 Wh/kg) | | | | | |
| Comparative | Yes | Yes | No | Yes | 0.48 | 0.67 | 5.6 | 1.24 |
| Example 1 | (75 Wh/kg) | | | | | | | |
| Comparative | Yes | Yes | No | Yes | 0.43 | 0.66 | 5.2 | 1.30 |
| Example 2 | (315 Wh/kg) | | | | | | | |
| Comparative | Yes | No | No | Yes | 0.47 | 0.67 | 5.4 | 1.00 |
| Example 3 | (75 Wh/kg) | | | | | | | |
| Comparative | Yes | Yes | No | Yes | 0.68 | 0.76 | 5.2 | 0.86 |
| Example 4 | (75 Wh/kg) | | | | | | | |
| Comparative | Yes | Yes | No | Yes | 0.28 | 0.52 | 6 | 1.83 |
| Example 5 | (190 Wh/kg) | | | | | | | |

| | Powder evaluation results | | | | | | Paste evaluation | |
|---|---|---|---|---|---|---|---|---|
| | | | | Arithmetic | | | results | |
| | | | | average | | Sa* | Viscosity | Viscosity |
| | D50 | D90 | Density | roughness Ra | Sa | D50 | (1 rpm) | (10 rpm) |
| | μm | | g/cm³ | nm | nm | nm2 | Pa · s | |
| Example 1 | 1.93 | 2.92 | 9.69 | 2.00 | 4.59 | 8859 | 73 | 42 |
| Example 2 | 1.84 | 2.80 | 9.67 | 2.09 | | | 80 | 42 |
| Example 3 | 1.38 | 2.06 | 9.34 | | 4.82 | 6652 | 134 | 82 |
| Example 4 | 2.71 | 3.99 | 9.67 | | 4.04 | 10948 | 61 | 34 |
| Comparative | 1.91 | 2.97 | 9.66 | 4.29 | 8.28 | 15815 | 95 | 51 |
| Example 1 | | | | | | | | |
| Comparative | 1.92 | 2.84 | 9.69 | 4.01 | | | 97 | 49 |
| Example 2 | | | | | | | | |
| Comparative | 2.00 | 3.60 | 9.70 | 4.25 | | | 90 | 52 |
| Example 3 | | | | | | | | |
| Comparative | 1.41 | 2.13 | 9.46 | | 13.80 | 19444 | 196 | 76 |
| Example 4 | | | | | | | | |
| Comparative | 2.71 | 4.07 | 9.74 | | 5.04 | 13658 | 71 | 38 |
| Example 5 | | | | | | | | |

TABLE 2

| | Rp | Rv | Rz | Rc | Rt | Ra | Rq | | |
|---|---|---|---|---|---|---|---|---|---|
| | [nm] | [nm] | [nm] | [nm] | [nm] | [nm] | [nm] | Rsk | Rku |
| Comparative Example 1 | 7.51 | 8.34 | 15.85 | 14.43 | 25.14 | 4.29 | 5.10 | −0.01 | 2.23 |
| Example 2 | 4.16 | 4.08 | 8.25 | 7.14 | 14.78 | 2.09 | 2.56 | 0.04 | 2.52 |

TABLE 3

| | Sa [nm] | Sz [nm] | Sp [nm] | Sv [nm] | Sq [nm] |
|---|---|---|---|---|---|
| Example 1 | 4.59 | 49.08 | 19.16 | 29.92 | 5.83 |
| Example 3 | 4.82 | 56.11 | 24.72 | 31.39 | 6.17 |
| Example 4 | 4.04 | 43.42 | 19.51 | 23.92 | 5.12 |
| Comparative | 8.28 | 92.32 | 42.86 | 49.45 | 10.84 |
| Example 1 | | | | | |
| Comparative | 13.79 | 128.68 | 57.59 | 71.08 | 17.39 |
| Example 4 | | | | | |
| Comparative | 5.04 | 54.24 | 30.72 | 23.52 | 6.47 |
| Example 5 | | | | | |

It can be seen from the tables presented in FIG. 11 and FIG. 12 that pastes in which the silver powders of the comparative examples are used each have a large number of disconnections in thin wire evaluation (EL) compared to pastes in which the silver powders of the examples are used. In other words, with the pastes in which the silver powders of the comparative examples are used, a large number of black sections where light is not omitted due to disconnection are observed as the drawn line width becomes thinner. In contrast, disconnection is significantly remedied with the pastes in which the silver powders of the examples are used. In other words, by using the silver powders of the examples, it is possible to provide a conductive paste that has low susceptibility to wire disconnection even upon low-temperature firing and wire thinning.

The reason that the silver powders of the examples exhibit an effect and characteristic of low susceptibility to wire disconnection even upon low-temperature firing and wire thinning (hereinafter, also referred as the effect according to the present disclosure) is thought to be that the surfaces of fine silver particles in the silver powders of the examples have an arithmetic average roughness Ra of 3 nm or less and have high packability during application. This is supported by the fact that the tap density in Examples 1 and 2 is higher than the tap density in Comparative Examples 1 to 3.

Note that since there is no significant difference in terms of density in the examples and comparative examples and since the specific surface areas of the silver powders of Examples 1 and 2 are the same or less than the specific surface areas of the silver powders of Comparative Examples 1 to 3, the effect according to the present disclosure can be judged to be achieved as a result of the second smoothing process. The fact that there is no significant difference in terms of D10, D50, and D90 in the examples and comparative examples also supports the judgment that the effect according to the present disclosure is achieved as a result of the second smoothing process.

It can also be seen that pastes in which the silver powders of the examples are used have significantly lower viscosity than pastes in which the silver powders of the comparative examples are used and that pastes in which the silver powders of the examples are used also have good coatability. Such improvement of coatability is also thought to be due to interactive force between particles in a paste being reduced as a result of the smoothing process.

Moreover, upon inspection of values for Rq, Rv, Rz, Rc, Rt, Rq, Rsk, and Rku other than the arithmetic average roughness (Ra) in Table 1, it can be seen that the silver powders of the examples undergo better smoothing compared to the silver powders of the comparative examples.

Furthermore, upon inspection of Sa in Table 1 and values for data in surface roughness measurement in Table 3, it can be seen that the silver powders of the examples are smoothed through the second smoothing process compared to the silver powders of the comparative examples. It can also be seen that as a result of the silver powders of the examples having a surface arithmetic average roughness of 4.9 nm or less in surface roughness measurement of a 500 nm×500 nm area, it is possible to provide a conductive paste having low susceptibility to wire disconnection even upon wire thinning as illustrated in the table in FIG. 11.

It can also be seen that a silver powder having a small volume-based median diameter experiences a greater effect of smoothing through the second smoothing process and has a greater amount of change of surface roughness than a silver powder having a large volume-based median diameter. Therefore, it is more preferable to implement smoothing such as to obtain a silver powder for which the product of a surface roughness value multiplied by volume-based median diameter is 12,000 nm² or less.

As set forth above, it is possible to provide a silver powder and a method of producing this silver powder.

### Alternative Embodiments

(1) In the preceding embodiment, a case in which the first surface smoothing step, the fine powder removal step, and the second surface smoothing step are performed in this order is described. Moreover, a case in which a coarse powder classification step is performed after the second surface smoothing step is described. However, the coarse powder classification step is not necessarily an essential step.

(2) In the preceding embodiment, a case in which the first surface smoothing step, the fine powder removal step, and the second surface smoothing step are performed in this order is described. Moreover, a case in which a coarse powder classification step is performed after the second surface smoothing step is described. However, a step like the fine powder removal step and a surface smoothing step like the first surface smoothing step or second surface smoothing step may be performed once or repeated a plurality of times after the second surface smoothing step. In other words, splitting up and performing a mechanical smoothing process a plurality of times and dispersing fine silver particles using high-pressure airflow while removing scraps in an interval in this smoothing process may be performed repeatedly. This repetition causes further progression of smoothing.

Note that configurations disclosed in the preceding embodiments (inclusive of alternative embodiments; same applies below) can be adopted in combination with configurations disclosed in other embodiments so long as they are not in contradiction. Also note that the embodiments disclosed in the present specification are examples and that embodiments of the present disclosure are not limited thereto and can be modified as appropriate to the extent that they do not deviate from the object of the present disclosure.

### INDUSTRIAL APPLICABILITY

The present disclosure can be adopted with respect to a silver powder and a method of producing this silver powder.

### REFERENCE SIGNS LIST

2 fine powder removal system
11 first smoothing device
12 second smoothing device
20 separating and dispersing device
21 fine powder removal device
22 coarse powder classifying device
100 production process
C coarse powder
CP agglomerate particle
F fine powder
FP scrap (fine powder)
J high-pressure airflow
L feedstock silver powder
LP1 feedstock particle
LP2 intermediate particle
LP3 intermediate particle
P product silver powder

1. A method of producing a silver powder comprising:
a first surface smoothing step of causing fine silver particles having internal voids to mechanically collide with one another;
a fine powder removal step of dispersing fine silver particles present after the first surface smoothing step using high-pressure airflow while removing fine powder; and
a second surface smoothing step of causing fine silver particles present after the fine powder removal step to mechanically collide with one another.

2. The method of producing a silver powder according to claim 1, further comprising a coarse powder classification step of removing coarse powder after the second surface smoothing step.

3. The method of producing a silver powder according to claim 1, wherein the fine powder removal step includes:
a separation and dispersion step of causing the fine silver particles to flow while continuously dispersing the fine silver particles using the high-pressure airflow and separating the fine powder from the fine silver particles; and
a fine powder classification step of classifying the fine silver particles that have undergone the separation and dispersion step to remove the fine powder.

4. The method of producing a silver powder according to claim 1, wherein the second surface smoothing step is continued until surfaces of the fine silver particles have an arithmetic average roughness of 3 nm or less in profile roughness measurement or surfaces of the fine silver particles have an arithmetic average roughness of 4.9 nm or less in surface roughness measurement of a 500 nm×500 nm area.

5. The method of producing a silver powder according to claim 1, wherein silver powder present after the second surface smoothing step has an apparent density of 9.8 g/cm³ or less.

6. A silver powder comprising fine silver particles having internal voids and having surfaces with an arithmetic average roughness of 3 nm or less in profile roughness measurement.

7. A silver powder comprising fine silver particles having internal voids and having surfaces with an arithmetic average roughness of 4.9 nm or less in surface roughness measurement of a 500 nm×500 nm area.

8. The silver powder according to claim 7, having internal voids and yielding a product of 12,000 nm² or less when the arithmetic average roughness of surfaces in surface roughness measurement of a 500 nm×500 nm area is multiplied by volume-based median diameter.

9. The silver powder according to claim 6, having an apparent density of 9.8 g/cm³ or less.

10. The silver powder according to claim 6, having a volume-based median diameter of not less than 1.0 μm and not more than 4.0 μm.

11. The silver powder according to claim 7, having an apparent density of 9.8 g/cm³ or less.

12. The silver powder according to claim 8, having an apparent density of 9.8 g/cm³ or less.

13. The silver powder according to claim 7, having a volume-based median diameter of not less than 1.0 μm and not more than 4.0 μm.

14. The silver powder according to claim 8, having a volume-based median diameter of not less than 1.0 μm and not more than 4.0 μm.
